(19) United States
(12) Patent Application Publication
(10) Pub. No.: US 2018/0271230 A1
(43) Pub. Date: Sep. 27, 2018

(54) Multi-functional Knitting Tool Bracelet

(71) Applicant: Jennifer Ann Ke'hauonalani Fahy, Burbank, CA (US)

(72) Inventor: Jennifer Ann Ke'hauonalani Fahy, Burbank, CA (US)

(21) Appl. No.: 15/530,938

(22) Filed: Mar. 27, 2017

(51) Int. Cl. A44C 5/00; D04B 3/00; G01B 3/10; D06H 7/00

(52) U.S. Cl. CPC A44C 5/003; A44C 5/0015; A44C 5/0092; A44D 2203/00; G01B 3/1082; D06H 7/00; D04B 3/00

(57) ABSTRACT

A multi-functional knitting tool bracelet is disclosed. The invention is comprised of a bracelet assembly worn around the wrist of a user and is configured with a plurality of linked, square members having imperial and metric graduations and indicia. Said members having various apertures to cut yarn, receive crochet needles of differing diameters as well as stitch markers therein. One end of the aforementioned bracelet having apertures adapted to receive and selectively secure a crochet hook and a tapestry needle—and another end configured with a counting mechanism to record stitches and rows heretofore. The bracelet is joined around a user's wrist by means of an adjustable, magnetic clasp. Objectives of the invention include aiding the process of knitting, crocheting, quilting, tapestry projects and the like by having popular tools within reach at all times. Specifically, an onboard ruler enhances measuring and can be laid flat against a fabric or substrate; the apertures allow for proper needle selection based on gauge diameter; additional apertures hold stitch markers at the ready; apertures on one end store extra needles and hooks; and a distal end houses flush, counting disks that can be turned with the fingers such that they keep track of stitches and rows etc. Having these onboard tools allows a user to work more efficiently by minimizing pauses normally associated with having to reach for commonly used equipment.

### FIELD OF THE INVENTION

The present invention generally relates to sewing tools—more specifically, to enhanced methods of knitting and crocheting tool accessibility.

### BACKGROUND OF THE INVENTION

Lower extremities such as the wrist and forearm offer a unique and readily-available attachment point for accessories that demand a high level of accessibility. One obvious example is the wristwatch—it has been available for hundreds of years and is still popular today due to its ease of accessibility. As trades became more specialized over the centuries, tool sets began to expand and researchers began inventing creative ways to make these tools more accessible to their users.

In more recent times, inventors have developed bracelets that temporarily secure tools to the wrist. U.S. Patent No. 20120324945A1 granted to Koeppel, disclosed an ornamental bracelet that can be used as a measuring device. The device can be easily removed from a user's wrist and laid flat against an object to be measured. U.S. Patent No.s 20080223889A1 and US 20120255978 A1 granted to Lam and Williams respectively, disclosed an ornamental bracelet that secures mobile devices (such as digital music players). U.S. Patent No.s 20050082323A1 and U.S. Pat. No. 7,048,162B2 granted to O′hair and Frye respectively, disclosed a wristband that holds various tools for mechanics. U.S. Patent No. 20140014696A1 and 20130020359A1 granted to Gwynn and Green respectively, disclosed a wrist storage bracelet for hairstylists allowing them easy access to a variety of scissors while performing haircuts. And U.S. Patent No.s 20140263910 and 20140263496 granted to Featherston and Zimmerman respectively, disclosed a wristband to temporarily hold writing and drawing instruments for use by artists. While many of these bracelets and wristbands are useful for holding a variety of tools for a myriad of functions, none were found in the prior art that were designed to incorporate a combination of knitting and crocheting tools such as rulers, yarn cutters and thread counters (collectively referred to as ‘notions’) into a single, multifunction bracelet.

### SUMMARY OF THE INVENTION

An objective of this invention is to provide a tool bracelet that enhances the efficiency of knitting and crocheting by combining several notions within easy reach on a user's wrist. The invention is comprised of a bracelet having hollow, square segments connected by interlocking pins.

Another objective is to allow users to measure without having to locate a ruler. Each side of the segments are graduated with both imperial and metric rulers. Users can obtain measurement estimates while wearing the device or can simply remove the invention and place it on a flat surface to obtain accurate measurements.

Another objective of the invention is to allow users to size knitting needles and crochet hooks without reaching for a size chart. Several sized holes are located in the center of each segment allowing a user to insert a crochet needle. Each hole is marked with a gauge size (0-16) so users can accurately determine the diameter of a needle or hook.

Another objective is to allow users to cut yarn without reaching for scissors. The largest needle sizing hole incorporates a small blade along its internal surface allowing users to insert and cut yarn using a pulling action. The blade is replaceable.

Another objective of the invention is to allow users to store stitch markers in close proximity to the work project. Included on the segments are small holes that allow users to insert and secure stitch markers.

Another objective is to allow users the ability to also store hooks and needles. One of the end segments has two holes that terminate at a small magnet allowing users to securely store a miniature steel crochet hook and tapestry needle.

Another objective of the invention is to allow users to keep track of knitting feature counts. The other end of the bracelet has two, flush-mounted, counter wheels (allowing four double-digit counting) on the terminal segment that can be rotated with fingers and helps users keep track of stitch counts, weave rows etc. The wheels are held in place by a tension spring and ball bearing assembly that temporarily secures the desired digits in the readout window. When the user presses down slightly on the wheels, the springs compress, allowing the wheels to be rotated. Upon arriving at the desired digit, the wheels are released and locked in place by means of small ball bearings that interlock the wheels and bracelet once again.

A final objective of the invention is to allow the bracelet to be easily donned and doffed and adjusted by means of a quick release magnet attached to a clasp that links to a small chain.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a perspective view of the present invention being used.

FIG. 2 is a perspective top view of the present invention.

FIG. 3 is a top, bottom and side view of the present invention.

FIG. 4 is an exploded view of the counter segment in the present invention.

FIG. 5 is an underside exploded view of the terminal segment with cutter and a section view of the terminal needle and hook segment of the present invention.

FIG. 6 is a top and section view of a bracelet segment having a cutter in the present invention.

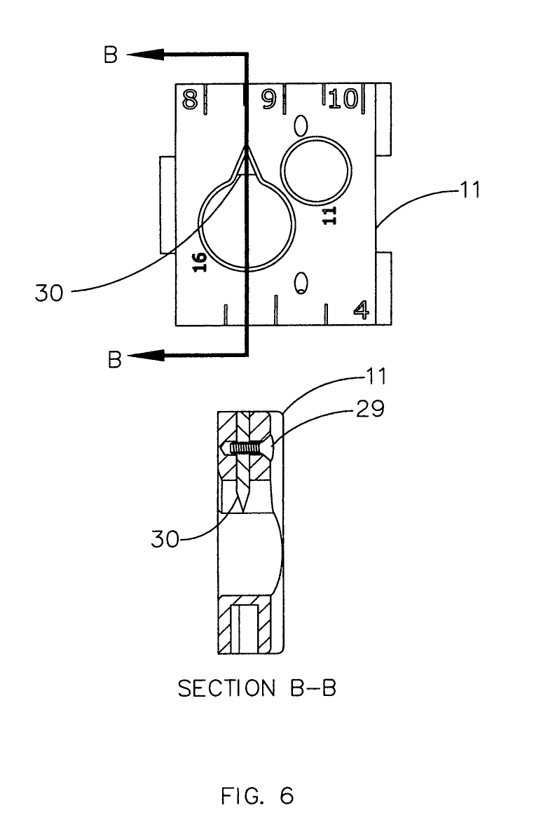

### DETAILED DESCRIPTION OF THE DRAWINGS

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments. Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

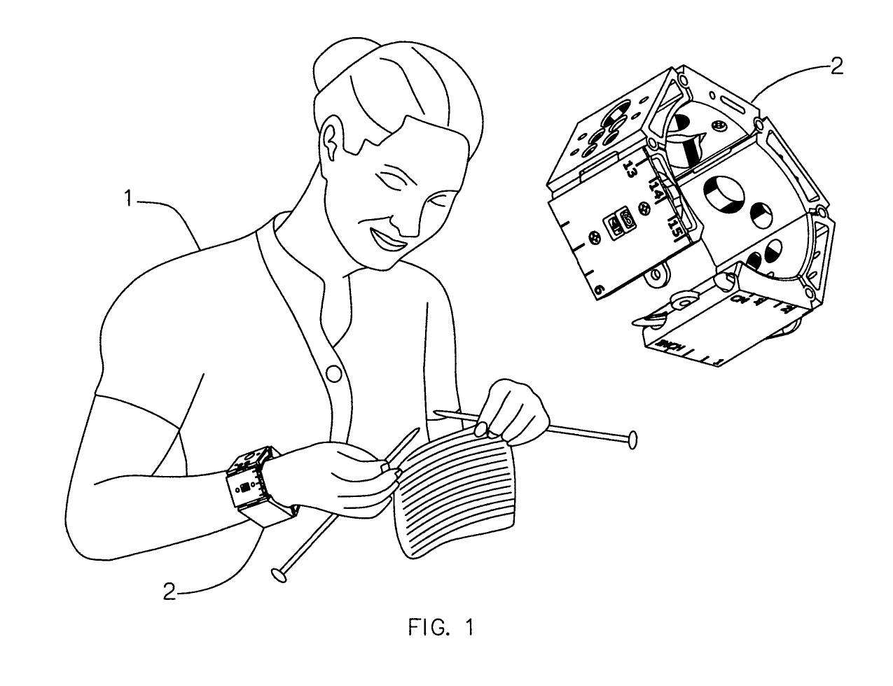

Referring now to the drawings wherein like reference characters identify corresponding or similar elements throughout the several views, FIG. 1 illustrates a perspective view of one embodiment according to the present invention 2 being worn by a user 1. The figure also shows a closeup, perspective view of invention 2 comprised of, but not limited to, six square-shaped segments joined by hinges. Each segment having angled, conjoining sides and an internal bottom shape configured such that when joined together, form an elliptical shape conforming to a user's 2 wrist. The aforementioned invention 2 being comprised of a rigid material such as, but not limited to, aluminum, steel, titanium, thermoplastic and the like.

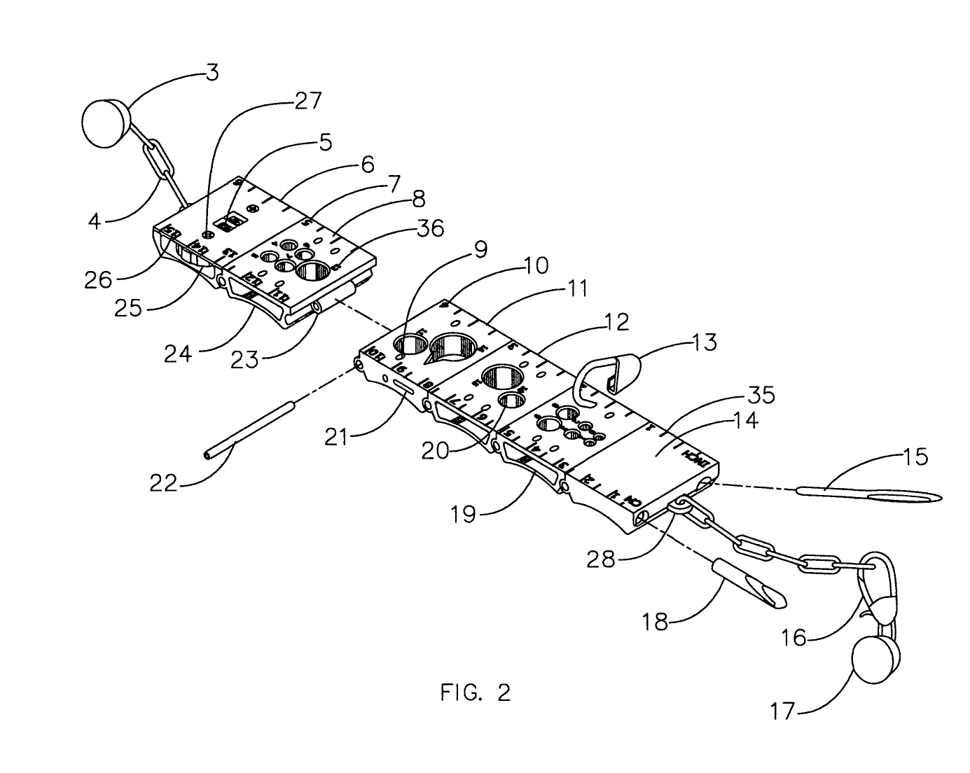

FIG. 2 illustrates a top view of the present invention 2 laid flat showing imperial ruler 7 having graduation marks 35 engraved on top surface perimeters of a side of each segment along with engraved imperial indicia 10. Other top surface perimeters distal to said imperial perimeters also having metric graduations and metric indicia 26. FIG. 2 showing said segments being pivotably and operatively joined by joining pin 22 inside hinges 23. Said pins 22 being made of a rigid material such as metal and plastic etc. The aforementioned invention 2 being releasably fastened together by means of chain 4 and clasp 16 attached to magnet fastener 17 on one end and chain 4 attached to magnet terminal 3 on a distal end of said invention 2. Said chains being affixed to each terminal segment by means of chain anchor 28. Said terminal 3 being made of a ferrous metal. FIG. 2 showing apertures on the side of a terminal segment 14 with needle 15 and hook 18 configured to receive needle 15 and hook 18. FIG. 2 illustrates stitch marker 13 installed into stitch marker orifice 9. The invention having, but not limited to, 14 orifices 9 on several segments being adapted at an angle away, and perpendicular to, the longitudinal axis of the aforementioned invention 2 to accommodate the shape of said stitch marker 13. The figure depicts several segments having hollow internal chambers 19 perpendicular to the longitudinal axis of invention 2. FIG. 2 illuminates a plurality of needle and hook sizing orifices 20 on four segments of invention 2 perpendicular to its longitudinal axis. Said orifices being of various diameters and marked with associated gauge indicia 36 on the surface of each segment. Said gauge sizes being from, but not limited to, zero to 16. This figure also shows at least two counter wheels 25 sandwiched inside counter segment 6 and being secured by counter plate screws 27.

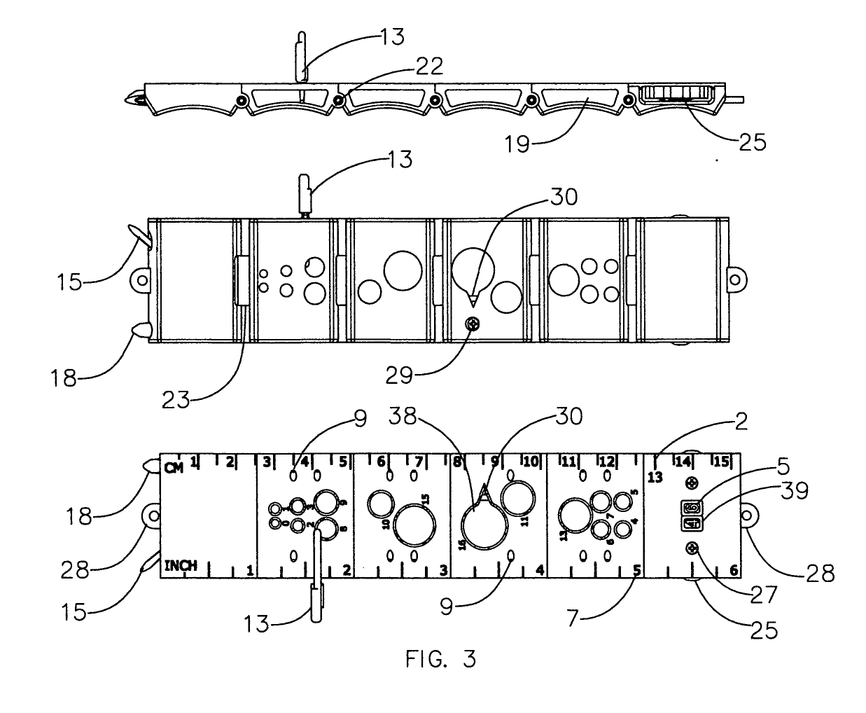

FIG. 3 illustrates a top, bottom and side view of the present invention 2 and cutting blade 30 being adapted inside notched sizing orifice 38 configured to receive a typical yarn. The figure shows blade anchor screw 29 being adapted perpendicular to the longitudinal axis of invention 2 to releasably anchor cutting blade 30. The top view this figure depicts the installation of stitch marker 13 inside orifice 9 being positioned at the ready. FIG. 3 also illustrates counter indicia 5 within counter window 39.

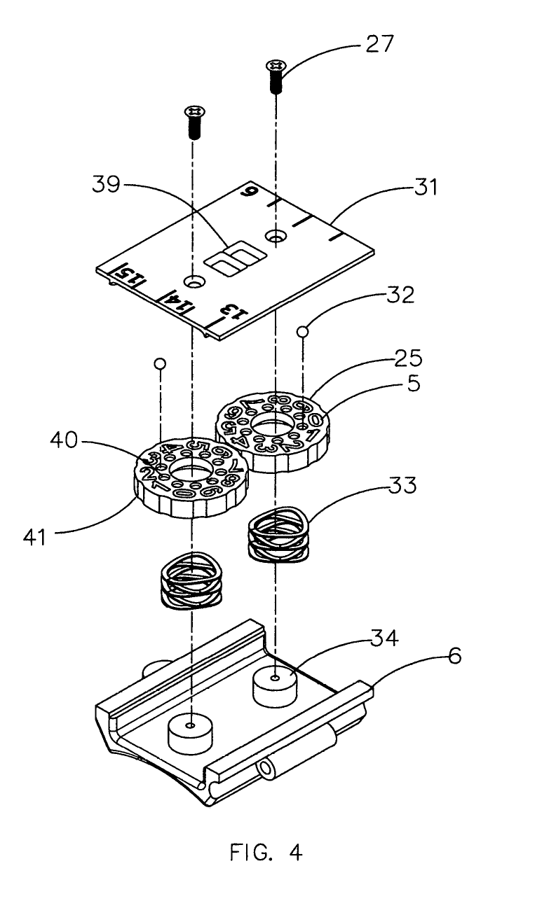

FIG. 4 illustrates an exploded perspective view of the counter segment showing counter assembly sandwiched between the segment base and counter plate 31. Said wheels 25 being comprised of cylindrical discs with notched grip perimeters 41 and an aperture in the center. Wheels 25 being constructed of a rigid material such as, but not limited to, metal, plastic and the like and having engraved numerical indicia 5 and ball bearing seats 40 configured in a radial pattern on a top surface of said wheels 25. Ball bearings 32 being spherical in shape and made of a rigid material such as metal and plastic etc. Said wheels having circular slots on another bottom side adapted to receive counter wheel tension springs 33. The springs 33 being made of a flexible material such as, but not limited to metals and plastics etc. Two cylindrical members 34 protruding upwards from the longitudinal axis of said segment base having diameters to allow said springs 33 to be slidably affixed to said segment and also allowing the springs to be supported in the same cylindrical axis of the wheels 25. The aforementioned assembly being sandwiched to the segment by means of two, counter plate screws 27 that pass through plate 31 and engage threads in the assembly apertures 42 configured in said members 34.

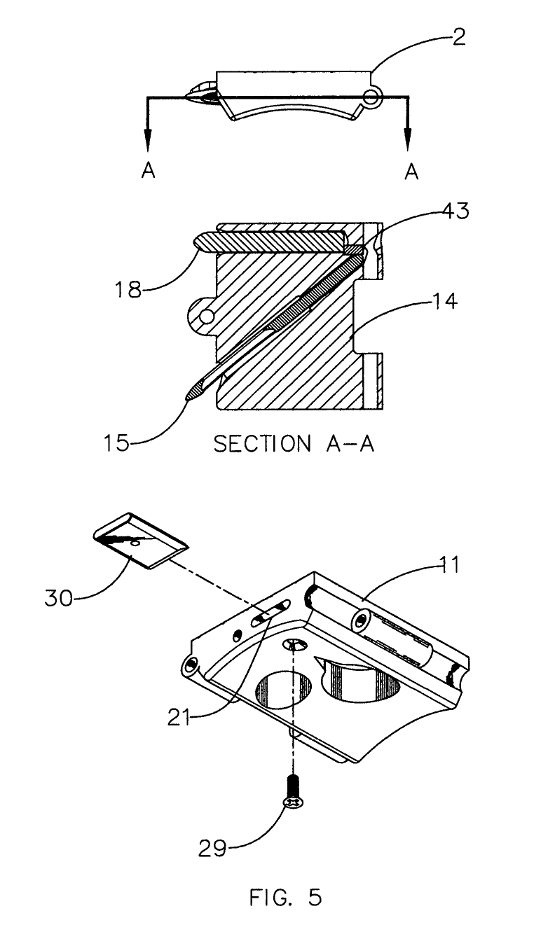

FIG. 5 is an underside, exploded view of the terminal segment with cutter and a section view of the terminal needle and hook segment of the present invention 2. Turning first to the exploded view showing cutting blade chamber 21 configured in a rectangular shape at an end of the segment, perpendicular to the invention's longitudinal axis and adapted to receive a replaceable cutting blade 30. Cutting blade 30 being made of a rigid, sharped material such as steel and the like and having an aperture at its center to allow blade anchor screw 29 to anchor it in position inside segment 11. Section A-A of FIG. 5 also shows terminal segment 14 with needle 15 and hook 18 being secured in storage chambers by means of chamber magnet 43. Said magnet being of a force great enough to hold needle 15 and hook 18 inside chambers while also allowing a user to selectively remove them.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A multi-functional knitting tool bracelet.

2. The multi-functional knitting tool bracelet of claim 1 wherein said bracelet enhances the efficiency of knitting and crocheting by combining several notions within easy reach on a user's wrist.

3. The multi-functional knitting tool bracelet of claim 1 wherein said bracelet having imperial and metric rulers on each side of its segments therein that when laid flat can accurately measure.

4. The multi-functional knitting tool bracelet of claim 1 wherein said bracelet having a plurality of apertures of various sizes and associated gauge indicia to determine needle sizes when needles are inserted therein.

5. The multi-functional knitting tool bracelet of claim 1 wherein said bracelet having a replaceable cutting blade inside said needle sizing apertures to allow yarn to be cut.

6. The multi-functional knitting tool bracelet of claim 1 wherein said bracelet having a multitude of angled apertures on segments to allow the storage of stitch markers and hold them at the ready.

7. The multi-functional knitting tool bracelet of claim 1 wherein said bracelet having storage tubes on and end of a terminal segment allowing for a single, miniature hook and needle to be stored and held in place by a small magnet therein.

8. The multi-functional knitting tool bracelet of claim 1 wherein said bracelet having double-digit counter wheels sandwiched inside a segment allowing users track thread counts and rows by turning wheels with fingers.
